(19) United States
(12) Patent Application Publication
(10) Pub. No.: US 2026/0240195 A1
(43) Pub. Date: Aug. 20, 2026

(54) FROZEN CONFECTION HOLDER

(71) Applicant: Models, LLC, Lebanon, IN (US)

(72) Inventors: Larry R. McMann, III, Lebanon, IN (US); Larry R. McMann, JR., Lebanon, IN (US); Zachary M. McMann, Lebanon, IN (US)

(73) Assignee: Pop Pal LLC, Lebanon, IN (US)

(21) Appl. No.: 19/539,600

(22) Filed: Feb. 13, 2026

Related U.S. Application Data
(60) Provisional application No. 63/758,587, filed on Feb. 14, 2025.

(51) Int. Cl. A23G 9/28

(52) U.S. Cl. CPC A23G 9/28

(57) ABSTRACT

A frozen confection holder used to advance iced portions away from tube packaging by pulling the tube packaging away from the frozen confection holder such that the iced portions remain. The frozen confection holder includes a flared end, a tubular body, an end cap, and a plurality of ribs positioned within the tubular body. The flared end is positioned along a proximal portion of tubular body, and the end cap is positioned along a distal portion of the tubular body. Accordingly, the flared end and the end cap are positioned at opposing ends of the tubular body. Positioned along an outside of the tubular body is an optional insulating layer which a user may hold onto in order to prevent heat transfer between the user and the iced portions.

### PRIORITY STATEMENT

This application claims priority of U.S. Provisional Patent Application No. 63/758,587, entitled “POPSICLE HOLDER,” filed February 14, 2025.

### BACKGROUND

Frozen confections are often distributed cold for consumption. This coldness can result in the frozen confection being painful or difficult to hold for extended periods of time. If enough time is spent holding the tube directly before consumption, this may lead to an undesirable thawing of consumable contents prior to consumption. Further, tubed frozen confections can be difficult for individuals to expose the iced consumable portions given the dexterity required to present and maintain the consumable portion in an exposed state outside of the tube. As an example, infants and toddlers may find it difficult to consume the consumable portions without the help of another individual.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements.

FIG. 1 is a front perspective view of a tube holder;

FIG. 2 is a rear perspective view of the tube holder of FIG. 1;

FIG. 3 is a front view of the tube holder of FIG. 1;

FIG. 4 is a cross-sectional view of the tube holder of FIG. 1, taken at line 4-4;

FIG. 5 is a front perspective view of the tube holder of FIG. 1 with a tube inside of the tube holder;

FIG. 6A a cross-sectional view of the tube holder of FIG. 1, taken at line 4-4, with the tube of FIG. 5 proximally positioned;

FIG. 6B a cross-sectional view of the tube holder of FIG. 1, taken at line 4-4, with the tube of FIG. 5 advancing distally;

FIG. 6C a cross-sectional view of the tube holder of FIG. 1, taken at line 4-4, with the tube of FIG. 5 distally positioned;

FIG. 7 is a rear view of the tube holder of FIG. 1 including a cross-sectional view of the tube of FIG. 6C;

FIG. 8 is a front perspective view of a second tube holder;

FIG. 9 is a rear perspective view of the second tube holder of FIG. 8;

FIG. 10 is a front view of the second tube holder of FIG. 8;

FIG. 11 is a cross-sectional view of the second tube holder of FIG. 8, taken at line 11-11.

### DETAILED DESCRIPTION

### First Frozen Confection Holder Example

The present disclosure relates to a frozen confection holder used to aid in the consumption of a tubed frozen confection. While a tubed frozen confection is presented herein, other forms of tubed consumable products are envisioned to work with the frozen confection holder. Some other nonlimiting forms may include tubed frozen yogurt, yogurt, custard, condiments, ice, ice and sugar, and ice cream.

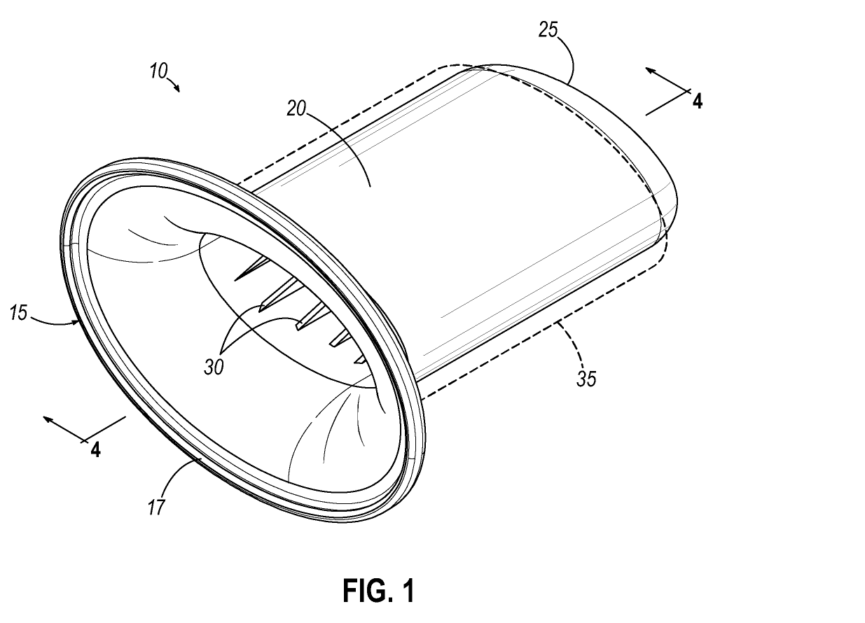

FIG. 1 shows a tube holder (10) having a flared end (15), a tubular body (20), an end cap (25), and a plurality of ribs (30) positioned within tubular body (20). Flared end (15) is positioned along a proximal portion of tubular body (20) and end cap (25) is positioned along a distal portion of tubular body (20). Accordingly, flared end (15) and end cap (25) are positioned at opposing ends of tubular body (20). Positioned along an outside of tubular body (20) is an optional insulating layer (35). Insulating layer (35) may be incorporated into flared end (15), tubular body (20), and/or end cap (25), or insulating layer (35) may be a separate component which is selectively removable from remaining portions of tube holder (10). Insulating layer (35) is configured and constructed to insulate a user’s hand from cold contents positioned within tubular body (20). Insulating layer (35) can include neoprene, polystyrene foam, foam, cloth, or anything apparent to a person of ordinary skill in the art.

Tubular body (20) includes an elongated elliptical profile sufficient to allow a user to grip tubular body (20) during use. The elongated elliptical profile thus includes a width that is longer than a height and includes bottom and top sides each extending along the width. Plurality of ribs (30) protrude from the bottom side of tubular body (20) toward a top side such that they are able to direct or ramp objects proximate the bottom side toward the top side. As will be shown later, plurality of ribs (30) extend from end cap (25), along at least a portion of tubular body (20), and towards flared end (15). Various ribs of the plurality of ribs (30) may define different angles from one another and relative to the bottom side such that they are able to direct objects toward the top side at different rates. Alternatively, a single ramp extending from the bottom side toward end cap (25) may be used.

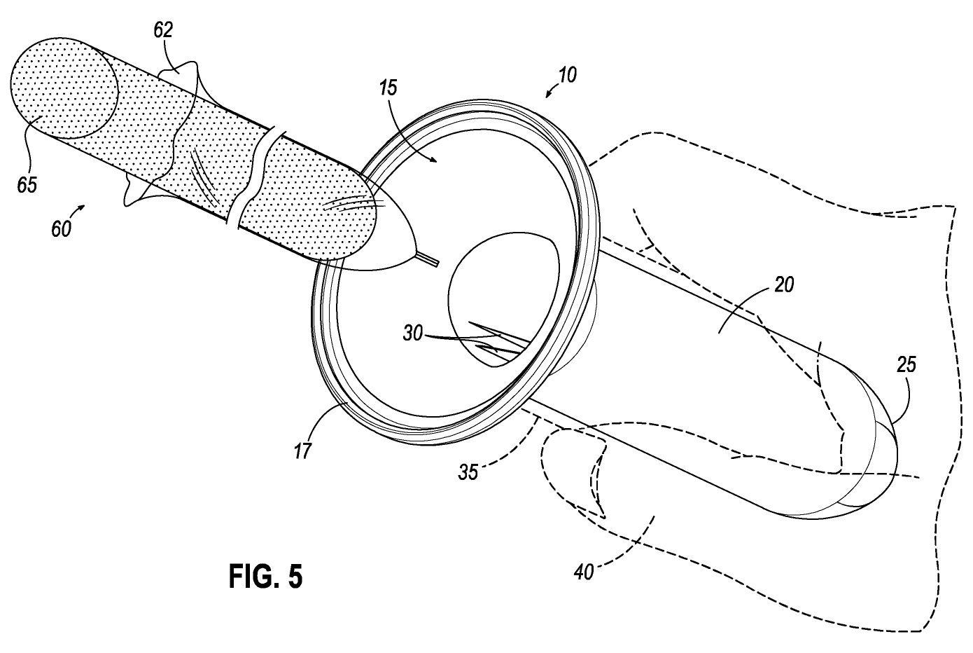

Flared end (15) extends from tubular body (20) in an arched or curved shape as shown in FIGS. 1–4 to thus act as a flange and/or funnel. As will be shown later, while a user is gripping tubular body (20) and pulling tube packaging (62) (see FIG. 5), flared end (15) tends to prevent tube holder (10) from slipping out of the user’s hand. Flared end (15) also acts as a funnel to aid in loading tube (60) (see FIG. 5) into tubular body (20) and to funnel fluids into tubular body (20). In some embodiments, flared end (15) may include a lip (17) configured to act as a catch to prevent dripping fluids from running down the arched portion of flared end (15).

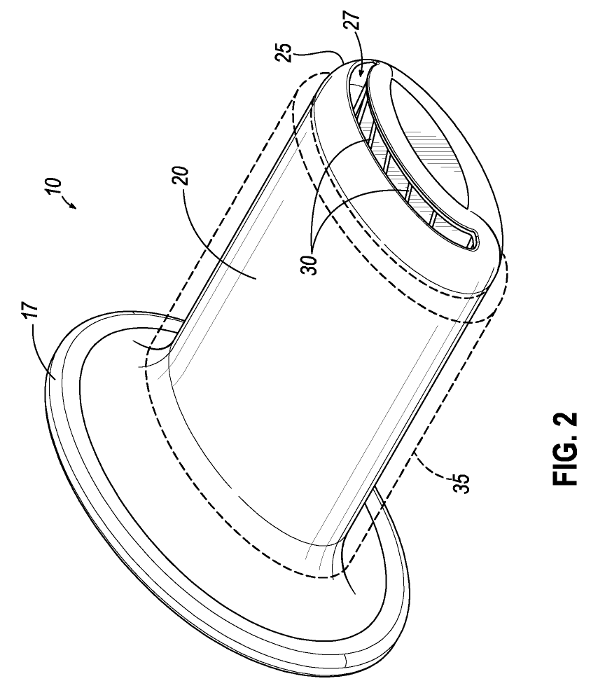

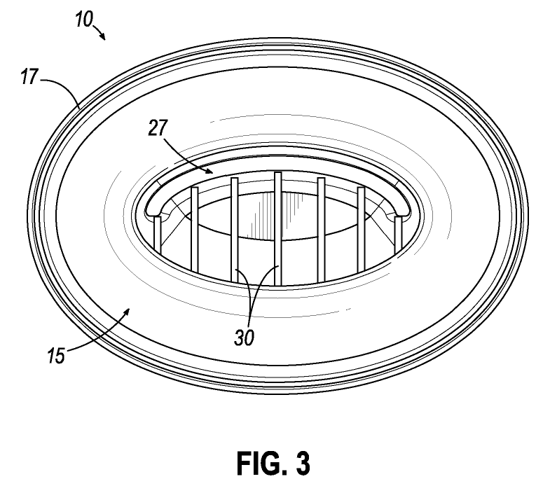

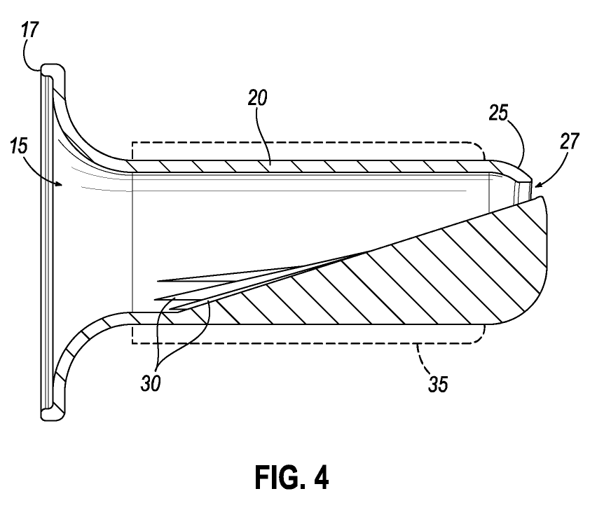

On the distal end of tubular body (20) is end cap (25), as shown in FIG. 2. End cap (25) extends from tubular body (20) and acts to seal distal end of tubular body (20) but for opening (27). As shown in FIGS. 2–3, opening (27) is slit-shaped and in some embodiments forms an arch or curve but may alternatively be straight. Opening (27) is used to bend or fold tube packaging (62) upon exiting tube holder (10). Opening (27) has a length that is at least half the circumference of tube packaging (60). In this way, tube packaging (62) may be prevented from crumpling once flattened as it is pulled through opening (27). As best shown in FIGS. 3–4, plurality of ribs (30) extends toward opening (27) to thereby guide tube packaging (62) towards opening (27) upon insertion of tube (60).

As shown, tube holder (10) may be shaped such that manufacturing of tube holder (10) can be performed via a straight-pull injection molding process. In other words, at least flared end (15), tubular body (20), end cap (25), and plurality of ribs (30) are shaped and tapered such that they can collectively be constructed using a straight-pull mold (not shown). As such, tube holder (10) may be presented as an integral/monolithic unit, and each surface of tube holder (10) may be tapered to allow for easy mold release from the straight pull mold.

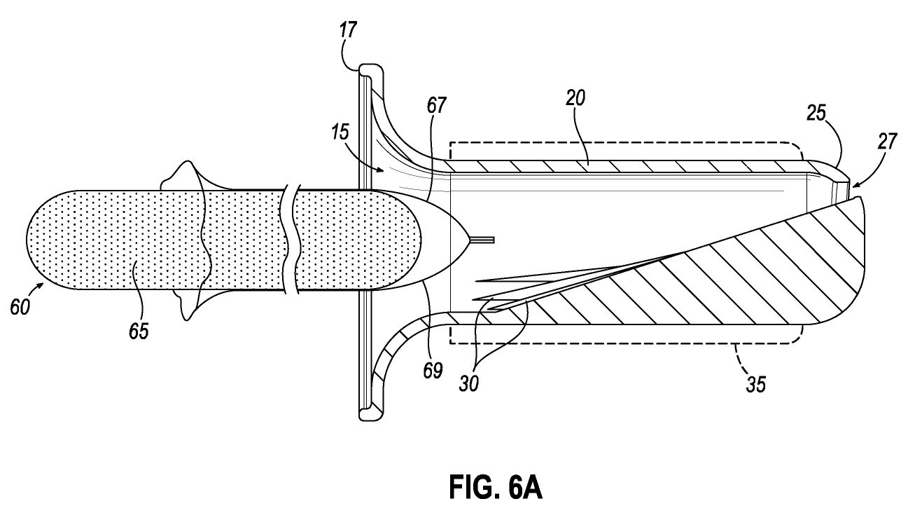

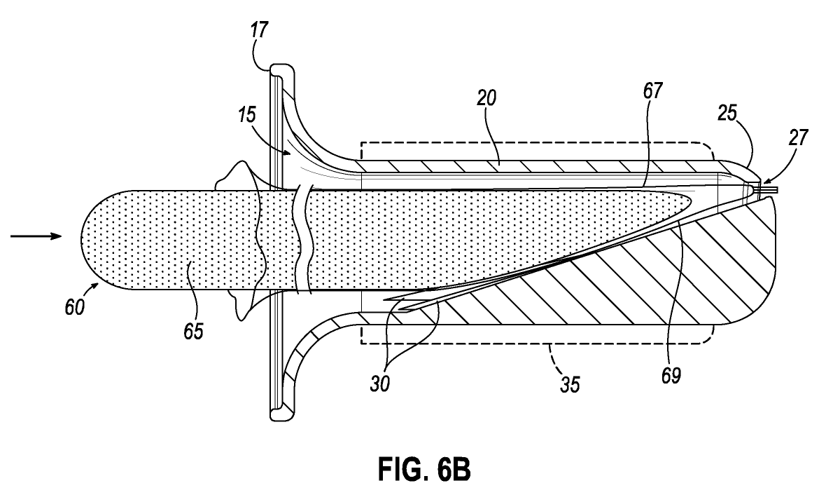

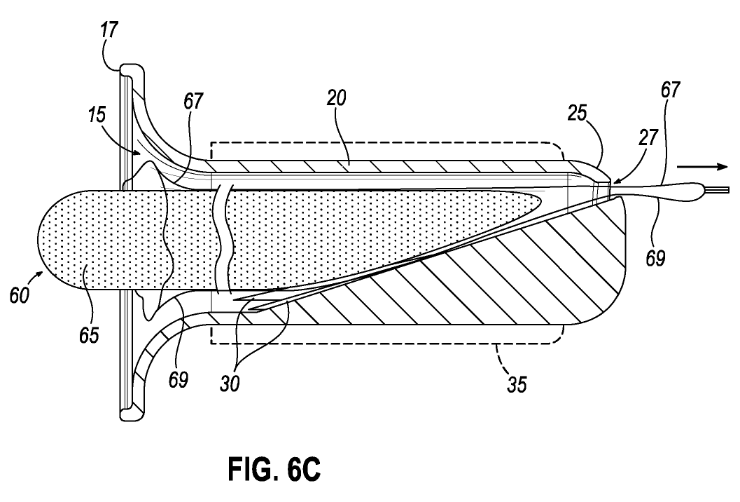

FIGS. 5–6C show tube holder (10) in use. As shown in FIG. 6A, hand (40) holds tube holder (10) along flared end (15) and tubular body (20) while tube (60) is guided into tubular body (20) by flared end (15). As tube (60) is inserted, tube packaging (62) contacts plurality of ribs (30) and is thus directed towards the top portion of tubular body (20) and opening (27). As tube (60) is advanced distally, tube packaging (62) contacts and slides along plurality of ribs (30). An upper portion (67) and a lower portion (69) of tube packaging (62) then begin to converge toward one another to thus pinch contents (65) of tube (60) housed within tube packaging (62). This pinching allows contents (65) to thus remain stationary relative to tube holder (10) as tube (60) moves. The result is relative motion between tube packaging (62) and contents (65), which exposes contents (65) to user at a proximal end of tube packaging (62). As contents (65) are consumed by user, less and less of the exposed portion of contents (65) will remain exposed for further consumption. A user may then pull distal end of tube packaging (62) further to expose more of contents (65). Tube packaging (62) may be a flexible and pliable material such that it can easily conform and slide around each rib of the plurality of ribs. Typical contents (65) may be of a semi-solid form, such as an ice and fluid-based mixture, and thus able to conform around each rib of the plurality of ribs (30). Because of this, contents (65) may maintain a fixed position relative to tube holder (10) such that tube packaging (62) easily slides between contents (65) and plurality of ribs (30).

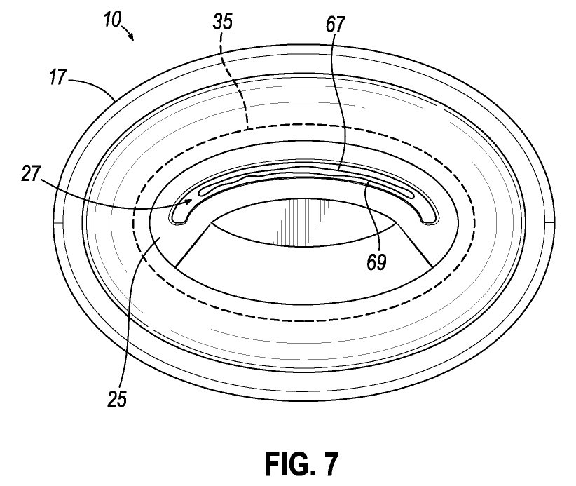

FIG. 7 shows a rear view of tube holder (10) and tube packaging (62) being cross-sectioned to illustrate upper portion (67) and lower portion (69) together. As mentioned above, the arched shape of opening (27) includes a length of at least one half the circumference of tube packaging (62). Opening (27) being sized in this way prevents crumpling of tube packaging (62) and allows a user to smoothly pull tube packaging (62) through opening (27). Further, the arched shape of opening (27) allows tube packaging (62) to be folded/bent/collapsed such that the upper portion (67) and the lower portion (69) of tube packaging (62) contact. This contact is beneficial for further exposure of contents (65) and to minimize any space/volume of a distal portion of tube packaging (62) that is distal beyond tube holder (10). By minimizing this space/volume, more of the contents (65) and fluids from contents (65) are available for consumption at the proximal end of tube packaging (62).

### Second Frozen Confection Holder Example

For certain loading tubes, it may be beneficial to include ribs on opposing sides of the body and distal cutouts to allow for ease of pulling the loading tube through.

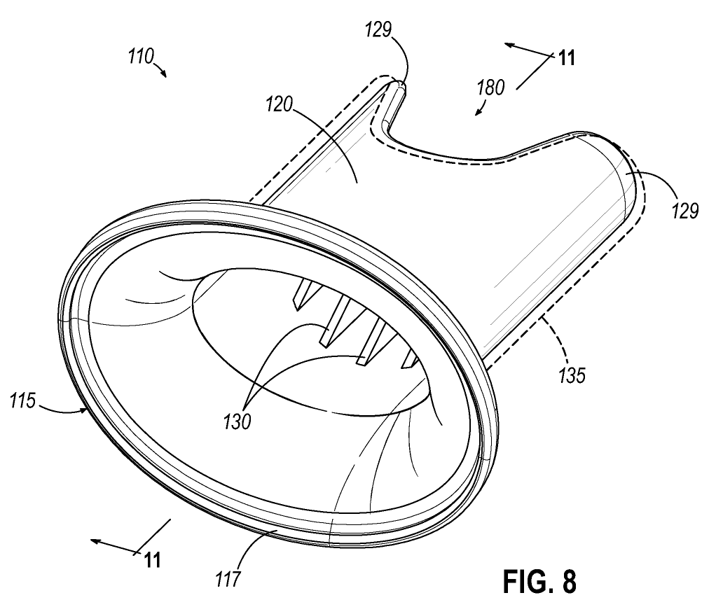

FIGS. 8–10 show a tube holder (110) having a flared end (115), a tubular body (120), an end cap (125), and a plurality of ribs (130) positioned within tubular body (120). Flared end (115) is positioned along a proximal portion of tubular body (120), and end cap (125) is positioned along a distal portion of tubular body (120). Accordingly, flared end (115) and end cap (125) are positioned at opposing portions of tubular body (120). Extending beyond end cap (125) are wings (129) along a sharper-radiused portion of tubular body (120). Wings (129) help to define openings (180). In combination, wings (129) provide the user more length to grip tube holder (110), while openings (180) allow the user to grab tube packaging (62) (analogous to the positions shown in FIGS. 5–6C) during initial placement.

Positioned along an outside of tubular body (120) is an optional insulating layer (135). Insulating layer (135) may be incorporated into flared end (115), tubular body (120), end cap (125), and/or wings (129), or insulating layer (135) may be a separate component that is selectively removable from remaining portions of tube holder (110). Insulating layer (135) is configured and constructed to insulate the user’s hand from cold contents positioned within tubular body (120). Insulating layer (135) can include neoprene, polystyrene foam, other foam, cloth, or anything apparent to a person having ordinary skill in the art.

Tubular body (120) includes an elongated elliptical profile sufficient to allow a user to grip tubular body (120) during use. The elongated elliptical profile thus includes a width that is longer than a height and includes bottom and top sides, each extending along the width. Each of a plurality of ribs (130) protrudes from the top or bottom side of tubular body (120) toward a middle such that they are able to direct or ramp objects proximate the top or bottom side of tubular body (120) toward the middle. As will be shown later, each of the plurality of ribs (130) extends from end cap (125), along at least a portion of the inside of tubular body (120), and towards flared end (115). Various ribs of the plurality of ribs (130) may define different angles from one another and relative to the bottom side such that they are able to direct objects toward the middle at different rates. Alternatively, a single rib (130) may extend from each of the top and the bottom side of tubular body (120) toward end cap (125).

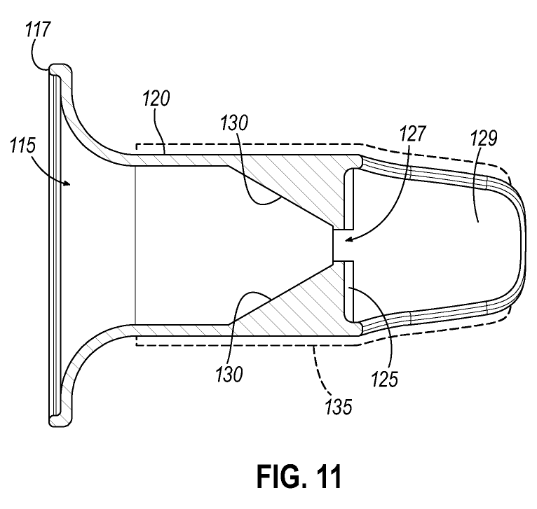

Flared end (115) extends from tubular body (120) in an arched or curved shape, as shown in FIGS. 8–11, to thus act as a flange and/or funnel. Similar to tube holder (10), while a user is gripping tubular body (120) and pulling tube packaging (62), flared end (115) tends to prevent tube holder (110) from slipping out of the user’s hand. Flared end (115) also acts as a funnel to aid in loading tube (60) into tubular body (120) and to funnel fluids into tubular body (120). In some embodiments, flared end (115) may include a lip (117) configured to act as a catch to prevent dripping fluids from running down the arched portion of flared end (115).

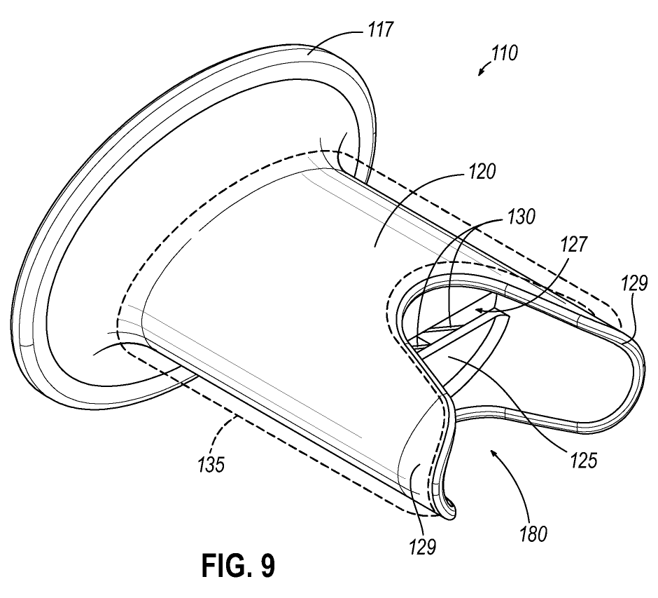

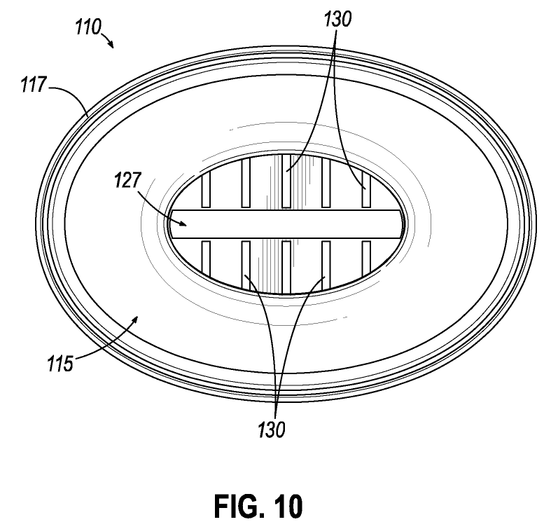

On the distal end of tubular body (120) is end cap (125), as shown in FIG. 9. End cap (125) extends from tubular body (120) and acts to seal distal end of tubular body (120) but for opening (127). As shown in FIGS. 9–10, opening (127) is slit-shaped, and in some embodiments is straight, but may alternatively be curved or arched-shaped. Optionally, opening (127) has a width (between the farthest points of wings (129)) that is at least half the circumference of tube packaging (60). In this way, tube packaging (62) may be prevented from crumpling once flattened as it is pulled through opening (127). As best shown in FIGS. 9-10, plurality of ribs (130) extends toward opening (127) to thereby guide tube packaging (62) towards opening (127) upon insertion of tube (60).

As shown, tube holder (110) may be shaped such that manufacturing of tube holder (110) can be performed via a straight-pull injection molding process. In other words, at least flared end (115), tubular body (120), end cap (125), plurality of ribs (130), and wings (129) are shaped and tapered such that they can collectively be constructed using a straight-pull mold (not shown). As such, tube holder (110) may be presented as an integral/monolithic unit, and each surface of tube holder (110) may be tapered to allow for easy release from the straight-pull mold.

### Miscellaneous

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

As used herein, an element or step recited in the singular and proceeded with the word “a” or “an” should be understood as not excluding plural of said elements or steps, unless such exclusion is explicitly stated. Furthermore, references to “one example” or “an example” are not intended to be interpreted as excluding the existence of additional examples that also incorporate the recited features. The use of “including,” “comprising,” or “having” and variations thereof herein is meant to encompass the items listed thereafter, and equivalents thereof, as well as additional items.

As used herein in the specification and claims, the terms “about,” “approximately,” “substantially,” “generally,” or similar terms used for any numerical values or ranges indicate a suitable dimensional tolerance, or other form of reasonable expected range, that allows the part or collection of components to function for its intended purpose as described herein. More specifically, these terms may refer to the range of values that are within ±10% of the recited value (e.g., “about 100” may refer to the range of values from 90 to 110, including 90, 110, 100, and all other values within the range of 90 and 110). Any numerical range recited herein is intended to include all sub-ranges subsumed therein. In other contexts, these terms are used herein to represent the degree by which a quantitative representation may vary from a stated reference without resulting in a change in the basic function of the subject matter at issue. Stated another way, these terms shall be understood to include a range of conditions or results that provide a functional equivalent to an explicitly stated condition or result. For instance, an apparatus including a component that is “substantially straight” may provide a result or effect that is functionally equivalent to a result or effect that would be achieved by the same apparatus including the same component in a perfectly straight configuration. The range implied by the term “substantially” should also be read to include the perfect result that is within that range.

### Examples of Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the examples below. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A tube holder, the tube holder comprising: a tubular body sized to fit a tube containing contents, the tubular body having a proximal portion and a distal portion; an end cap positioned along the distal portion, the end cap including an opening sized for the tube to pass through without the contents; and a plurality of ribs positioned within the tubular body, proximate the distal portion, the plurality of ribs being configured to guide the tube through the opening while maintaining a position of at least a portion of the contents of the tube relative to the tube holder.

### Example 2

The tube holder of example 1, the opening being an elongated slit.

### Example 3

The tube holder of any one of examples 1–2, the opening including a profile configured to collapse the tube.

### Example 4

The tube holder of any one of examples 1–3, the opening including a length that is at least half of a circumference of the tube.

### Example 5

The tube holder of any one of examples 1–4, the tubular body including an elliptical profile having an elongated width relative to a height.

### Example 6

The tube holder of any one of examples 1–5, the plurality of ribs extending towards the opening.

### Example 7

The tube holder of any one of examples 1–6, a rib of the plurality of ribs varying in at least one dimension from another rib of the plurality of ribs.

### Example 8

The tube holder of any one of examples 1–7, a first rib of the plurality of ribs defining a first angle relative to an inside of the tubular body, and a second rib of the plurality of ribs defining a second angle relative to the inside of the tubular body, the first angle and the second angle being different.

### Example 9

The tube holder of any one of examples 1–8, the tube holder further comprising an insulating body around an outside of the tubular body.

### Example 10

The tube holder of example 9, the insulating body including neoprene.

### Example 11

The tube holder of any one of examples 1–10, the tube holder being monolithic.

### Example 12

The tube holder of any one of examples 1–11, the tube holder being configured for manufacture via straight pull injection molding.

### Example 13

The tube holder of any one of examples 1–12, the tube holder further comprising a flange along the proximal portion.

### Example 14

The tube holder of example 13, the flange being flared away from the tubular body.

### Example 15

The tube holder of example 13, the flange being configured to funnel fluids into the tubular body.

### Example 16

A tube holder, the tube holder comprising: a tubular body sized to fit a tube containing contents, the tubular body having a proximal portion and a distal portion; and an end cap positioned along the distal portion, the end cap including an opening sized for the tube to pass through without the contents, the opening including a profile configured to collapse the tube to thereby remove the contents from the tube.

### Example 17

The tube holder of example 16, the tube holder including a plurality of ribs positioned within the tubular body and configured to remove the contents from the tube.

### Example 18

The tube holder of any one of examples 16–17, wherein the contents are a frozen confection, and the contents include ice.

### Example 19

A method of using a tube holder to remove contents from a tube, the tube holder including a tubular body being a proximal portion and distal portion, a plurality of ribs positioned within the tubular body and along the distal portion, and an end cap along the distal portion and having an opening, the method including: inserting the tube inside the tubular body at the proximal portion; engaging the tube with the plurality of ribs to thereby maintain a position of the contents relative to the tube holder; and pulling the tube out of the opening to thereby separate the tube from the contents.

### Example 20

The method of example 19, the tube holder further including a flange, the method further including inserting the tube between the flange and the tubular body.

We claim:

1. A tube holder, the tube holder comprising:
(a) a tubular body sized to fit a tube containing contents, the tubular body having a proximal portion and a distal portion;
(b) an end cap positioned along the distal portion, the end cap including an opening sized for the tube to pass through without the contents; and
(c) a plurality of ribs positioned within the tubular body, proximate the distal portion, the plurality of ribs being configured to guide the tube through the opening while maintaining a position of at least a portion of the contents of the tube relative to the tube holder.

2. The tube holder of claim 1, the opening being an elongated slit.

3. The tube holder of claim 1, the opening including a profile configured to collapse the tube.

4. The tube holder of claim 1, the opening including a length that is at least half of a circumference of the tube.

5. The tube holder of claim 1, the tubular body including an elliptical profile having an elongated width relative to a height.

6. The tube holder of claim 1, the plurality of ribs extending towards the opening.

7. The tube holder of claim 1, a rib of the plurality of ribs varying in at least one dimension from another rib of the plurality of ribs.

8. The tube holder of claim 1, a first rib of the plurality of ribs defining a first angle relative to an inside of the tubular body, and a second rib of the plurality of ribs defining a second angle relative to the inside of the tubular body, the first angle and the second angle being different.

9. The tube holder of claim 1, the tube holder further comprising an insulating body around an outside of the tubular body.

10. The tube holder of claim 9, the insulating body including neoprene.

11. The tube holder of claim 1, the tube holder being monolithic.

12. The tube holder of claim 11, the tube holder being configured for manufacture via straight pull injection molding.

13. The tube holder of claim 1, the tube holder further comprising a flange along the proximal portion.

14. The tube holder of claim 13, the flange being flared away from the tubular body.

15. The tube holder of claim 13, the flange being configured to funnel fluids into the tubular body.

16. A tube holder, the tube holder comprising:
(a) a tubular body sized to fit a tube containing contents, the tubular body having a proximal portion and a distal portion; and
(b) an end cap positioned along the distal portion, the end cap including an opening sized for the tube to pass through without the contents, the opening including a profile configured to collapse the tube to thereby remove the contents from the tube.

17. The tube holder of claim 16, the tube holder including a plurality of ribs positioned within the tubular body and configured to remove the contents from the tube.

18. The tube holder of claim 16, wherein the contents are a frozen confection, and the contents include ice.

19. A method of using a tube holder to remove contents from a tube, the tube holder including a tubular body being a proximal portion and distal portion, a plurality of ribs positioned within the tubular body and along the distal portion, and an end cap along the distal portion and having an opening, the method including:
(a) inserting the tube inside the tubular body at the proximal portion;
(b) engaging the tube with the plurality of ribs to thereby maintain a position of the contents relative to the tube holder; and
(c) pulling the tube out of the opening to thereby separate the tube from the contents.

20. The method of claim 19, the tube holder further including a flange, the method further including inserting the tube between the flange and the tubular body.
